(19) United States
(12) Patent Application Publication
(10) Pub. No.: US 2020/0170766 A1
(43) Pub. Date: Jun. 4, 2020

(54) DENTAL FLOSS

(71) Applicants: SUNSTAR INC., Osaka (JP); Nishinokaze Gizyutsu Kobo, LLC, Osaka (JP)

(72) Inventors: Atsushi KINUGASA, Hyogo (JP); Kousuke TORII, Osaka (JP); Kunio NISHIMOTO, Osaka (JP)

(21) Appl. No.: 16/702,050

(22) Filed: Dec. 3, 2019

(30) Foreign Application Priority Data
Dec. 3, 2018 (JP) 2018-226325

(51) Int. Cl. A61C 15/04

(52) U.S. Cl. CPC A61C 15/041; A61C 15/043

(57) ABSTRACT

A dental floss 2 containing a multifilament is a flat braided cord. The number of threads constituting the flat braided cord is preferably 6 to 33, and the dental floss preferably has a width of 0.5 to 4.0 mm, and a passage gap of 0.01 to 0.1 mm. The flat cord may contain a monofilament or a multifilament-connected thread together with the multifilament. Constituent threads of the braided cord are obliquely arranged and fixed, and, when the cord is moved in a length direction, the obliquely fixed constituent threads efficiently remove food residue, dental plaque, and the like between teeth. Furthermore, the flat braided cord is flat and thin, and easy to insert between teeth. Accordingly, a dental floss that can efficiently remove food residue, dental plaque, and the like between teeth is provided.

### BACKGROUND OF THE INVENTION

### 1. Field of the Invention

The present invention relates to a dental floss for removing food residue, dental plaque, and the like between teeth.

### 2. Description of Related Art

Conventionally, there are various tools for removing food residue, dental plaque, and the like between teeth, such as interdental brushes, toothpicks, dental floss, toothbrushes, and soft rubber picks. These tools are used by many people every day JP 2013-192586A proposes a dental floss composed of a multifilament with an irregular-shaped cross-section that is a multileaf-shaped cross-section. JP 2010-214017A proposes a thread with a fineness of 500 to 1500 decitex obtained by bundling filaments with a single fiber fineness of 10 decitex or less and coated with a water-soluble polymer. JP 2006-141456A proposes a dental floss composed of a false twisted thread.

However, conventional dental floss is problematic in that it cannot efficiently remove food residue, dental plaque, and the like between teeth.

### SUMMARY OF THE INVENTION

In order to address the above-described conventional problem, the present invention provides a dental floss that can efficiently remove food residue, dental plaque, and the like between teeth.

The dental floss of the present invention is directed to a dental floss containing a multifilament, wherein the dental floss is a flat braided cord.

The dental floss of the present invention contains a multifilament, and is a flat braided cord, and thus it can efficiently remove food residue, dental plaque, and the like between teeth. That is to say constituent threads of the braided cord are obliquely arranged and fixed, and, when the cord is moved in a length direction, the obliquely fixed constituent threads efficiently remove food residue, dental plaque, and the like between teeth. Furthermore, the flat braided cord is flat and thin, and easy to insert between teeth.

### BRIEF DESCRIPTION OF THE DRAWINGS

FIG. 1 is a front view of a dental floss product fixed to a holder according an embodiment of the present invention.

FIG. 2 is a front view of a dental floss product fixed to a holder according to another embodiment of the present invention.

FIG. 3 is a schematic view showing an apparatus for producing a flat braided cord that is a material for a dental floss according to an embodiment of the present invention.

FIG. 4 is a cross-sectional view of a four-polyester-monofilament-connected thread that is used in an example of the present invention.

FIG. 5A is a perspective photo of a passage gap measurement device that is used in examples of the present invention.

FIG. 5B is a perspective photo showing the measurement state in the examples.

FIG. 6A is a plan photo of a braided cord cleaning test machine in the examples.

FIG. 6B is a perspective photo of the braided cord cleaning test machine in the examples.

FIG. 6C is a photo of a powder applicator of the braided cord cleaning test machine in the examples.

FIG. 6D is a photo showing a measurement state of the braided cord clearing test machine in the examples.

FIG. 6E is a photo showing a cleaning state of a braided cord in the examples.

FIG. 6F is a data photo of the photo in FIG. GE that has undergone image processing in the examples.

### DETAILED DESCRIPTION OF THE INVENTION

A dental floss of the present invention contains a multifilament, and is a flat braided cord. The multifilament is preferably a synthetic fiber such as a polyester thread, a nylon thread, a fluoropolymer resin fiber thread, or the like. The number of constituent filaments of the multifilament is preferably 10 to 40, and the total fineness is preferably 500 to 1500 decitex.

The number of threads constituting the flat braided cord is preferably 6 to 33. Within this range, the dental floss is thin, and easy to insert between teeth. Furthermore, if the number of threads constituting the braided cord is as described above, the constituent threads of the braided cord are obliquely arranged and fixed, and, when the cord is moved in a length direction, the obliquely fixed constituent threads efficiently remove food residue, dental plaque, and the like between teeth.

The dental floss has a width of preferably 0.5 to 4.0 mm, and more preferably 1 to 2.2 mm. If the width is within this range, the dental floss is easy to insert between teeth, and can efficiently remove food residue, dental plaque, and the like between teeth. In a similar manner, the gap through which the dental floss can pass is preferably 0.01 to 0.1 mm, and more preferably 0.02 to 0.05 mm.

The flat cord may contain a monofilament as a constituent fiber together with the multifilament. If a monofilament is also employed, the flat cord can more efficiently remove food residue, dental plaque, and the like between teeth. The monofilament is preferably a multifilament-connected thread. A multifilament-connected thread is, for example, a thread in which approximately two to five filaments are connected. If a multifilament-connected thread is added, the flat cord can more efficiently remove food residue, dental plaque, and the like between teeth. The monofilament has a fineness of preferably 2.6 to 4.6 decitex.

It is also preferable that the braided cord of the present invention is composed of a multifilament false twisted thread, or contains a multifilament false twisted thread. False twisted threads have fine crimps, and thus they can efficiently remove food residue, dental plaque, and the like between teeth. Moreover, the insertability and the durability are improved.

It is preferable that the dental floss is wound on a spool or held on a dental floss holder. If the dental floss is wound on a spool, the dental floss is used after being cut to a predetermined length. If the dental floss is held on a dental floss holder, cleaning between teeth is performed while holding the holder.

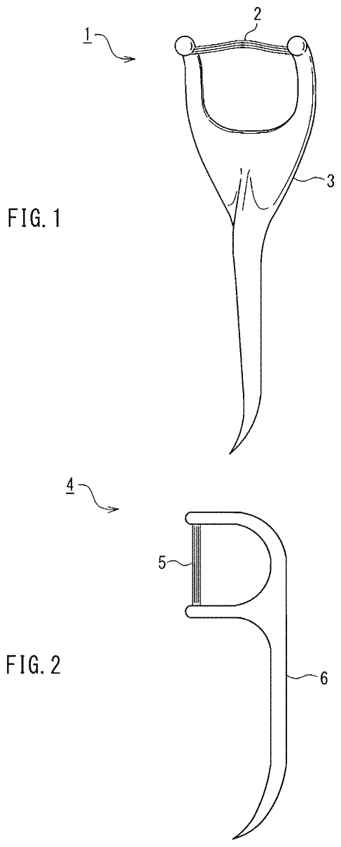

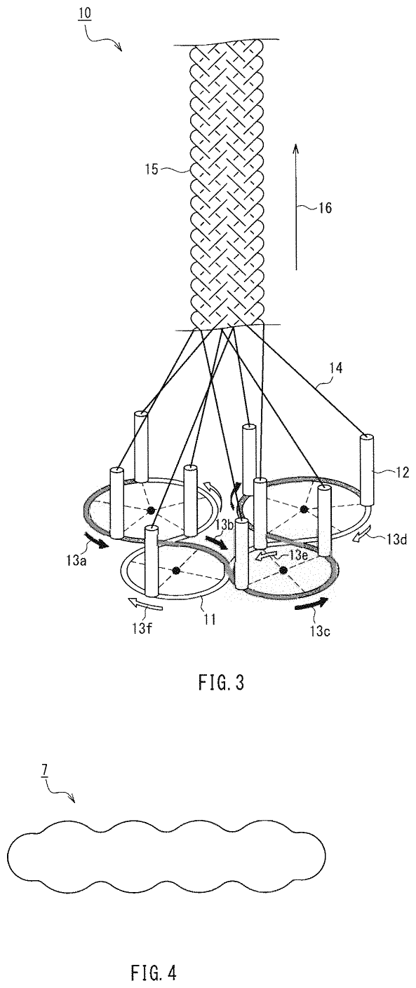

Hereinafter, a description will be made with reference to the drawings. In the following drawings, the same reference numerals denote the same constituent elements. FIG. 1 is a front view of a dental floss product fixed to a holder according to an embodiment of the present invention. In this dental floss product 1, a dental floss 2 is fixed to a holder 3. FIG. 2 is a front view of a dental floss product fixed to a holder according to another embodiment of the present invention. In this dental floss product 4, a dental floss 5 is fixed to a holder 6.

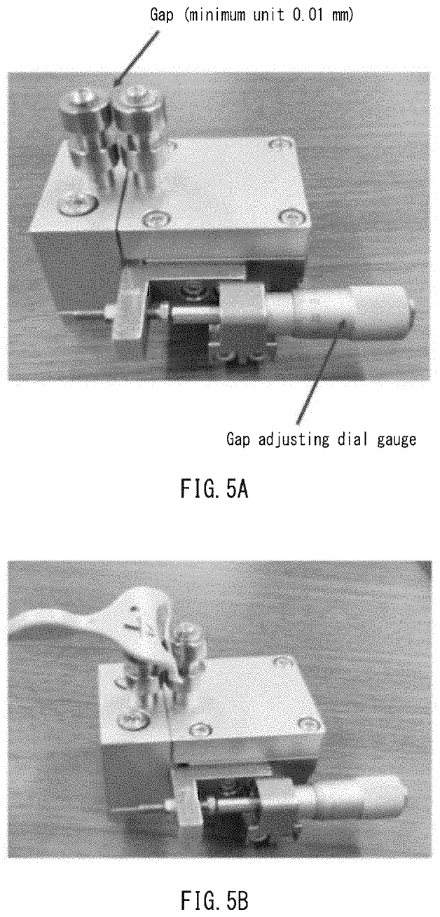

FIG. 3 is a schematic view showing an apparatus for producing a flat braided cord that is a material for a dental floss according to an embodiment of the present invention. In a flat braided cord production apparatus 10 of this example, nine bobbins (thread pieces) 12 on four stands (rails) 11 rotate along tracks as indicated by the arrows 13a to 13f, and fiber threads 14 fed from the respective bobbins (carriers) 12 are braided, so that a braided cord 15 is formed. The arrow 16 is a braiding direction. In this example, wound threads are set on all of the nine bobbins (thread pieces) 12, but wound threads may be set on only some of the bobbins (thread pieces) 12, or different types of wound threads may be partially set. In the present invention, the number of bobbins (thread pieces) is referred to as a “total thread piece number”, and the number of constituent threads of a braided cord is referred to as a “winding number”.

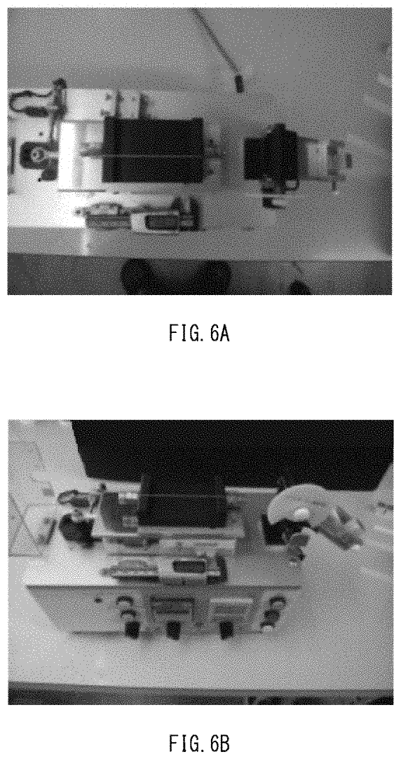

FIG. 4 is a cross-sectional view of a four-polyester-monofilament-connected thread 7 that is used in an example of the present invention.

### EXAMPLES

Hereinafter, the present invention will be more specifically described by way of examples, but the invention is not limited to the following examples.

First, evaluation methods will be described.

### Passage Gap

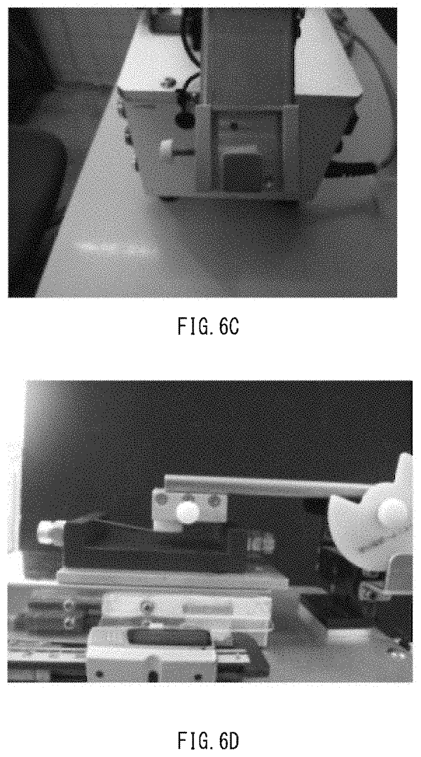

A gap through which a workpiece (measurement sample) can pass was measured using a passage gap measurement device shown in FIGS. 5A and 5B. This measurement device can measure a passage gap in the unit of 0.01 mm.

### Actual Insertability

An actual insertability was determined from the insertability and the smoothness when a workpiece was inserted between actual teeth (several points between front teeth).

A: Very good

B: Good

C: Average

### Durability (Friction)

After a workpiece was moved back and forth 50 times (stroke length 15 mm) using the passage gap measurement device shown in FIGS. 5A and 5B, whether or not the floss had frayed was checked.

A: Not frayed

B: Frayed, but not problematic in practice

### Cleaning Evaluation 1 (Lengthwise Direction)

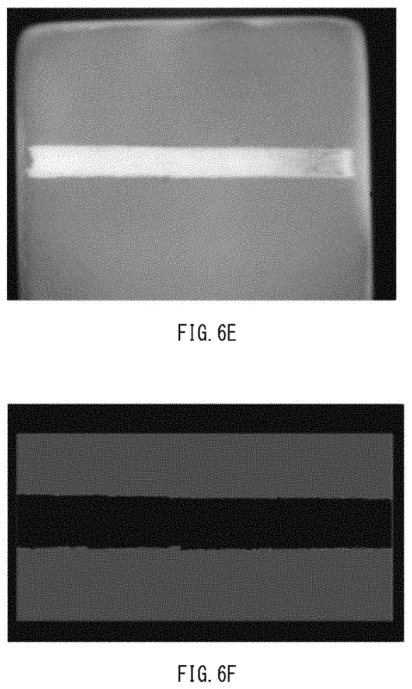

In a braided cord cleaning test machine shown in FIGS. 6A to 6D, a cube covered in powder was brought into contact with and slid over a taut braided cord, once with a stroke of 10 mm in the lengthwise direction of the braided cord. An image of the cube was captured using a microscope, and the area from Which powder had been removed was measured. The cube is made of acrylic resin and 16.0±0.1 mm on each side. FIG. 6E is a photo of the sample during the measurement. The load of the device was set to 100 g, and evaluation was performed after the cube with a weight of 6 g attached to the device was brought into contact with the braided cord. FIG. 6F is a data photo of the photo in FIG. GE that has undergone image processing. The center of the cube surface shown in FIG. 6E is a portion subjected to cleaning, and powder was removed therefrom. The cube surface was measured as follows.

(1) Capture an image at 20 times using a microscope (VHX-6000 manufactured by Keyence Corporation)

(2) Extract a portion with a size of 5 mm×10 mm

(3) Calculate the area remaining after removal (e.g., 36.079 mm²)

(4) Define the area 13.921 mm² obtained by subtracting the remaining area from the entire area. (50 mm²) as clearing power

### Cleaning Evaluation 2 (Widthwise Direction)

In the braided cord cleaning test machine shown in FIGS. 6A to 6D, a cube covered in powder was brought into contact with and slid over a taut braided cord, once with a stroke of 10 mm in the widthwise direction of the braided cord. As in the case of the lengthwise direction, an image of the cube was captured using a microscope, and the area from which powder had been removed was measured.

### Example 1

A braided cord was produced by setting 11 wound threads each composed of a polyethylene terephthalate (PET) multifilament thread (total fineness: 78 decitex, the number of constituent filaments: 24) and two wound threads each composed of a PET multifilament spun-dyed black thread (total fineness: 110 decitex, the number of constituent filaments: 24) to the flat braided cord production apparatus 10 shown in FIG. 3. “Total thread piece number” was set to 13, and “winding number” was set to 13 as well. The obtained flat braided cord was fixed to the holder shown in FIG. 1 and subjected to various evaluations such as insertability between teeth. The conditions and evaluation results are summarized in Table 1.

### Example 2

A braided cord was produced by setting seven wound threads each composed of a polyethylene terephthalate (PET) multifilament thread (total fineness: 78 decitex, the number of constituent filaments: 24) to the flat braided cord production apparatus 10 shown in FIG. 3. “Total thread piece number” was set to 13, and “winding number” was set to 7. The obtained flat braided cord was fixed to the holder shown in FIG. 1 and subjected to various evaluations such as insertability between teeth.

### Example 3

An experiment was performed as in Example 1, except that seven wound threads each composed of a polyethylene terephthalate (PET) multi filament thread (total fineness: 78 decitex, the number of constituent filaments: 24) and six wound threads each composed of a PET multifilament thread (total fineness: 56 decitex, the number of constituent filaments: 18) were used.

### Example 4

An experiment was performed as in Example 1, except that 13 wound threads each composed of a polyethylene terephthalate (PET) multifilament thread (total fineness: 56 decitex, the number of constituent filaments: 18) were used.

### Example 5

An experiment was performed as in Example 1, except that 11 wound threads each composed of a polyethylene terephthalate (PET) multifilament thread (total fineness: 56 decitex, the number of constituent filaments: 18) and two wound threads each composed of a four-PET-monofilament-connected thread (fineness 3.6 decitex) were used. The cross-sectional view of the four-PET-monofilament-connected thread is as shown in FIG. 4.

### Example 6

An experiment was performed as in Example 1, except that 25 wound threads each composed of a polyethylene terephthalate (PET) false twisted thread (total fineness: 75 decitex, the number of constituent filaments: 36) were used.

### Example 7

An experiment was performed as in Example 1, except that 13 wound threads each composed of a polyethylene terephthalate (PET) false twisted thread (total fineness: 75 decitex, the number of constituent filaments: 36) and 12 wound threads each composed of a PET false twisted thread (fineness: 50 decitex, the number of constituent filaments: 36) were used.

### Example 8

An experiment was performed as in Example 1, except that 25 wound threads each composed of a polyethylene terephthalate (PET) false twisted thread (total fineness: 50 decitex, the number of constituent filaments: 36) were used.

### Example 9

An experiment was performed as in Example 1, except that 25 wound threads each composed of a polyethylene terephthalate (PET) false twisted thread (total fineness: 30 decitex, the number of constituent filaments: 36) were used.

### Example 10

An experiment was performed as in Example 1, except that 25 wound threads each composed of a polyethylene terephthalate (PET) false twisted thread (total fineness: 30 decitex, the number of constituent filaments: 12) were used.

### Example 11

An experiment was performed as in Example 1, except that 13 wound threads each composed of a polyethylene terephthalate (PET) false twisted thread (total fineness: 50 decitex, the number of constituent filaments: 36) and 12 wound threads each composed of a PET false twisted thread (total fineness: 50 decitex, the number of constituent filaments: 36) were used.

### Example 12

An experiment was performed as in Example 1, except that 20 wound threads each composed of a polyethylene terephthalate (PET) false twisted thread (total fineness: 50 decitex, the number of constituent filaments: 36) were used.

The evaluation results are summarized in Tables 1 to 3.

TABLE 1

| No. | | Example 1 | Example 2 | Example 3 | Example 4 |
|---|---|---|---|---|---|
| Condition | A. Material: fineness: winding number | PET: 78T: 11 | PET: 78T: 7 | PET: 78T: 7 | PET: 78T: 13 |
| | B. Material: fineness: winding number | PET: 110T black: 2 | — | PET: 56T: 6 | — |
| | Total thread piece number | 13 | 7/13 | 13 | 13 |
| Evaluation | Floss width (mm) | 1.30 | 1.00 | 1.30 | 1.30 |
| result | Passage gap (mm) | 0.05 | 0.03 | 0.04 | <0.03 |
| | Tensile strength (N) | 46 | 5 | 29 | 15 |
| | Actual insertability | C | B | B | B |
| | Durability (friction) | B | B | B | B |
| | Cleaning Evaluation 1 | 3.49 | 4.86 | 2.73 | 3.90 |
| | (lengthwise direction, mm²) | | | | |
| | Cleaning Evaluation 2 | 7.65 | 14.30 | 10.58 | 4.60 |
| | (widthwise direction, mm²) | | | | |

(Note)
Unit T of fineness refers to decitex. The same shall apply hereinafter.

TABLE 2

| No. | | Example 5 | Example 6 | Example 7 | Example 8 |
|---|---|---|---|---|---|
| Condition | A. Material: fineness: winding number | PET: 56T: 11 | PET: EW75D: 25 | PET: EW75D: 13 | PET: EW75D: 25 |
| | B. Material: fineness: winding number | PET: 4 connected mono: 2 | — | PET: EW50D: 12 | — |
| | Total thread piece number | 13 | 25 | 25 | 25 |
| Evaluation | Floss width (mm) | 1.30 | 2.20 | 2.00 | 1.80 |
| result | Passage gap (mm) | 0.04 | 0.04 | 0.04 | 0.03 |
| | Tensile strength (N) | 16 | 85 | 68 | 60 |
| | Actual insertability | B | C | C | B |
| | Durability (friction) | A | A | A | A |
| | Cleaning Evaluation 1 | 4.40 | 8.45 | 7.85 | 13.37 |
| | (lengthwise direction, mm²) | | | | |
| | Cleaning Evaluation 2 | 1.0.00 | 15.50 | 9.1.8 | 1.63 |
| | (widthwise direction, mm²) | | | | |

(Note)
Thread “EW” used in Examples 6 and thereafter is a false twisted thread.

TABLE 3

| No. | | Example 9 | Example 10 | Example 11 | Example 12 |
|---|---|---|---|---|---|
| Condition | A. Material: fineness: winding number | PET: EW30D: 25 | PET: EW30D: 25 | PET: EW50D: 13 | PET: EW50D: 20 |
| | B. Material: fineness: winding number | | | PET: EW30D: 12 | — |
| | Total thread piece number | 25 | 25 | 25 | 20/25 |
| Evaluation | Floss width (mm) | 1.30 | 1.30 | 1.50 | 1.30 |
| result | Passage gap (mm) | <0.03 | <0.03 | 0.03 | <0.03 |
| | Tensile strength (N) | 19 | 19 | 36 | 35 |
| | Actual insertability | A | A | B | B |
| | Durability (friction) | A | A | A | A |
| | Cleaning Evaluation 1 | 4.60 | 7.05 | 8.54 | 8.33 |
| | (lengthwise direction, mm²) | | | | |
| | Cleaning Evaluation 2 | 11.18 | 6.80 | 20.18 | 12.58 |
| | (widthwise direction, mm²) | | | | |

It is clearly seen from these results that the dental flosses of the examples according to the present invention contain a multifilament, and are flat braided cords, and thus they can efficiently remove food residue, dental plaque, and the like between teeth. That is to say, constituent threads of the braided cords are obliquely arranged and fixed, and, when the cords are moved in a length direction, the obliquely fixed constituent threads efficiently remove food residue, dental plaque, and the like between teeth. Furthermore, the flat braided cords are flat and thin, and easy to insert between teeth.

It will be appreciated that the dental floss of the present invention is effective not only for those with healthy teeth but also for those with dentures (false teeth) or dental implants.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A dental floss containing a multifilament,
wherein the dental floss is a flat braided cord.

2. The dental floss according to claim 1, wherein the number of threads constituting the flat braided cord is 6 to 33.

3. The dental floss according to claim 1, wherein the dental floss has a width of 0.5 to 4.0 mm.

4. The dental floss according to claim 1, wherein a gap through which the dental floss can pass is 0.01 to 0.1 mm.

5. The dental floss according to claim 1, wherein the braided cord contains a monofilament as a constituent fiber together with the multifilament.

6. The dental floss according to claim 5, wherein the monofilament is a multifilament-connected thread.

7. The dental floss according to claim 1, wherein the braided cord is composed of a multifilament false twisted thread, or contains a multifilament false twisted thread.

8. The dental floss according to claim 1, wherein the dental floss is wound on a spool or held on a dental floss holder.
